(19) United States
(12) Patent Application Publication
(10) Pub. No.: US 2025/0010404 A1
(43) Pub. Date: Jan. 9, 2025

(54) AUTOMATED SYSTEM AND PROCESS FOR WELDING

(71) Applicant: ICL CATODOS LTDA., Calama (CL)

(72) Inventor: Patricio Antonio CARRACEDO MESCHI, Calama (CL)

(73) Assignee: ICL CATODOS LTDA., Calama (CL)

(21) Appl. No.: 18/889,511

(22) Filed: Sep. 19, 2024

(30) Foreign Application Priority Data
Sep. 22, 2023 (CL) 202302829

(51) Int. Cl. B23K 31/02; B23K 37/00; B23K 37/02; B23K 37/04; B23K 101/36

(52) U.S. Cl. CPC B23K 31/02; B23K 37/003; B23K 37/0252; B23K 37/0435; B23K 2101/36

(57) ABSTRACT

An automated system and process for the welding joint of a cathode plate with a conductive bar is described. The automated system includes a welding table and at least one welding device. The automated system and process ensures the uniformity and linearity of the welding seam, avoiding welding defects, favoring the structural unity and conductivity of the permanent cathode, extending its service life and improving the quality of the product obtained.

### CROSS-REFERENCE TO RELATED APPLICATIONS

This application claims priority to Chilean patent application No. 202302829, filed on Sep. 22, 2023. The aforementioned patent application is incorporated by reference in its entirety.

### FIELD OF THE INVENTION

The present invention is developed in the field of the manufacture, maintenance and repair of permanent cathodes used in the processes of electro-winning or electro-refining of metals, specifically, it refers to an automated system and process for the joining by welding of a cathode plate with a conductive bar.

### BACKGROUND OF THE INVENTION

In electrolytic processes for production of metals, the permanent cathodes correspond to the negative pole of the process, which consist of a conductive bar and a plate or sheet, usually made of stainless steel or titanium, which is suspended by the conductive bar at one of its ends. These cathodes are placed inside a solution called “electrolyte”, generally composed of a salt of a metal to be electrolyzed, where, when a direct current circulates, reactions take place that produce the deposition of the metal on the surface of the plates of said permanent cathodes.

In order to form the permanent cathode, the upper edge of the plate and the lower part of the conductive bar are joined by a welding bead applied on both sides of the plate. Typically, to produce the joint, the upper edge of the plate is inserted into a longitudinal groove in the lower part of the conductive bar, ensuring the contact between these elements, favoring the structural strength of the permanent cathode, to subsequently weld the conductive bar and the plate, for example, by means of a TIG (tungsten inert gas) system, generating a welded joint on both sides.

The connection between the conductive bar and the plate is essential for the operation of the permanent cathode, being necessary to ensure the structural integrity of the permanent cathode, to favor the electrical conductivity of the assembly and to avoid voltage drops due to defective contact of the parts.

Generally, the welding of the conductive bar and the permanent cathode plate is done manually, so that the quality and characteristics of the welding seam obtained will depend on the expertise of the operator in charge of the process. In addition to the above, non-uniform temperature conditions at the work site and differences in the materials of the conductive bar and plate promote the generation of defects such as pores or cracks in the welding bead and/or welding deformation of the cathode plate. In particular, the difference in the melting points in the materials of the conductive bar and plate can produce deviations in the weld that cause the welding bead obtained not to be completely linear.

These defects affect the durability of the welded joint, the mechanical resistance and conductivity of the permanent cathode, also facilitating the occurrence of voltage drops, affecting the quality of the product obtained from the electrolytic processes.

In view of the above, it is important to reduce the factors that may affect the bond between the conductive bar and the permanent cathode plate, in order to ensure the uniformity of the welding bead and thus improve the final quality of the product obtained.

In the state of the art, solutions have been developed to improve the welding process of the conductive bar and plate of permanent cathodes.

In this regard, document KR20110083976A describes a welding apparatus for a cathode plate for electro refining, comprising a main frame, which supports the elements of the apparatus, a fixing device of the cathode plate on the main frame, which secures the position of said cathode plate and bar, a rotating platform, between the main frame and the fixing device, which allows rotating said fixing device, a welding robot, operated to weld the bar and the plate on both sides, and a cooling device to reduce the temperature in the joining zone. The described welding apparatus is aimed at avoiding welding defects such as cracks, undercuts and pores, and reducing the deformation of the plate produced due to welding, however, this paper does not address the problem of welding deviations due to the difference in the melting points of the materials of the joining elements that cause the weld bead to be non-linear.

The present application provides an automated system and process for the welding joint of a cathode plate with a conductive bar that ensures the uniformity and linearity of the welding seam, avoiding welding defects, enhancing the structural unity and conductivity of the permanent cathode, extending its service life and improving the quality of the product obtained, and also reduces manual operations in the manufacturing and/or repair process of permanent cathodes.

### SUMMARY OF THE INVENTION

The present invention refers to an automated system and process for the welding joint of a cathode plate with a conductive bar that ensures the uniformity and linearity of the welding seam, avoiding welding defects, favoring the structural unity and conductivity of the permanent cathode, extending its service life and improving the quality of the product obtained.

Another objective of the invention is to provide an automated system and process for welding joints that reduces manual operations in the manufacturing and/or repair process of permanent cathodes, reducing the direct intervention of operators and the associated risks.

The invention consists in automating a welding process between a plate, typically of stainless steel 316L, duplex or any type of stainless steel for cathodes, and a conductive bar, preferably of copper, of a cathode used in electrolytic processes. The welding process uses a conductive bar comprising a filler portion, which constitutes a welding filler material incorporated, previously in the conductive bar, to generate the fusion, being the filler portion disposed in the lower part of the conductive bar, which is in contact with the plate in the cathode assembly.

Alternatively, the welding filler material or fillet metal could come from an automatic feed of a welding alloy. In one embodiment, the welding alloy can be a special copper welding alloy.

The process is performed by means of an automated system comprising a mobile and rotating welding table, which can hold at least one conductive bar and a plate of a permanent cathode; gripping means, on the welding table, to fix and immobilize the conductive bar and plate so that when the welding process is started, no deviations occur; at least one welding device that allows to generate a welding bead in a linear, constant and continuous way.

The welding table also includes guides that indicate the position and place where the conductive bar is to be positioned and a reference element for positioning the conductive bar at the same starting point. The rotation of the welding table is generated by rotating means that allow the welding to be produced on both sides of the joint zone of the conductive bar and the plate without the need for additional movements of the welding device. Additionally and as a product of this automation, the welding table comprises cooling means to maintain a constant temperature while the welding is being performed. The welding table comprises drive means or actuators to generate the rotation of the welding table, regulating also, its speed, and activate the movement of the gripping means to fix and immobilize the conductive bar and plate, defining a clamping pressure. The operation of the cooling means allows to regulate the cooling of the bar to a constant temperature required by this new process.

The at least one welding device allows adjusting the speed and amperage at which the welding is performed. In one embodiment, the at least one welding device corresponds to a TIG welding device.

The at least one welding device comprises sensor means for detecting deviations in the weld due to the difference in the melting points of the materials of the conductive bar and plate, to perform an automatic correction in the movement and/or operating parameters of the at least one welding device to ensure the linearity of the welding bead that is generated.

The at least one welding device can be programmed to set the number of movements required for the welding process.

The automated system is connected to at least one control panel that contains the commands so that an operator can operate the system components without intervening directly.

In one embodiment, the welding process, using the automated system, comprises the following steps:
i. Positioning a conductive bar comprising a filler portion, which constitutes incorporated weld filler material, on the welding table;
ii. Adjusting the position of the conductive bar, fixing it and immobilizing it on the welding table;
iii. Positioning a plate on the welding table, so that its upper edge is in contact with the lower part of the conductive bar, which comprises the filler portion, on the welding table;
iv. Welding the conductive bar and plate on the first side of the contact zone between the conductive bar and plate, generating melting in the filler portion of the conductive bar;
v. Welding the conductive bar and plate on a second side, opposite to said first side, of the contact zone between the conductive bar and plate, generating fusion in the filler portion of the conductive bar, forming an assembled permanent cathode;
vi. Removing the assembled permanent cathode to a required location.

The conductive bar is positioned on the gripping means of the welding table, at the starting point indicated by the reference element and guides that mark the position and place where the conductive bar should be placed.

The welding of the conductive bar and plate is performed by the at least one welding device, where the weld is generated on the first side and then the welding table is rotated so that the second side is facing the at least one welding device, allowing the weld to be generated.

### BRIEF DESCRIPTION OF THE DRAWINGS

The accompanying drawings are included to provide a greater understanding of the invention and constitute part of this description and further illustrate a preferred embodiment of the invention, wherein it is seen that:

FIG. 1 shows a schematic arrangement of the automated system for the welding joint of a cathode plate with a conductive bar, in accordance with one embodiment of the invention.

FIG. 2 shows a schematic flow of the automated process for the welding joint of a cathode plate with a conductive bar, in accordance with one embodiment of the invention.

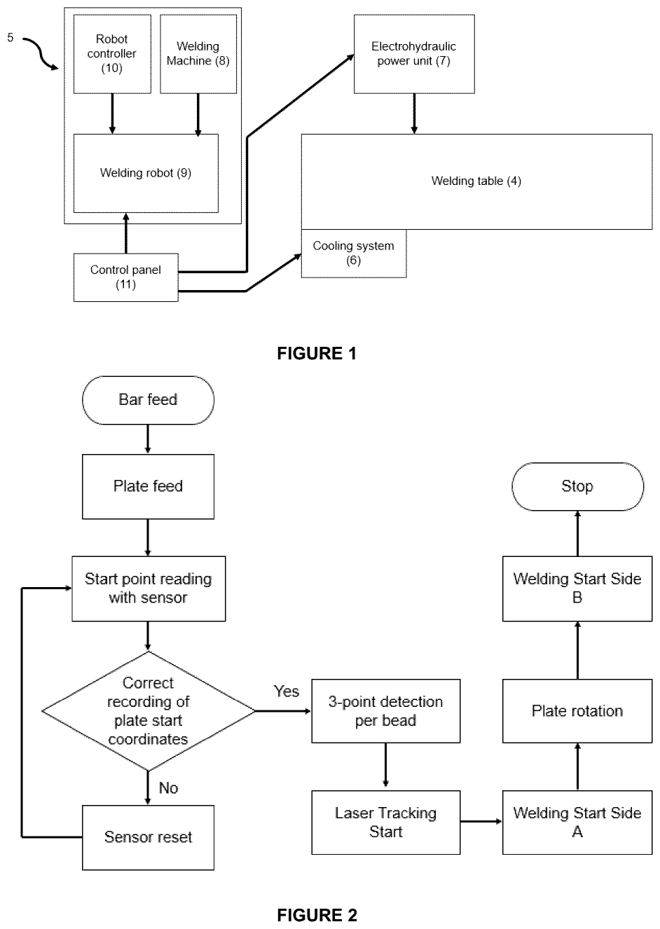

### DETAILED DESCRIPTION OF THE INVENTION

The present invention refers to an automated system (1) for the welding joint of a cathode plate (2) with a conductive bar (3) that ensures the uniformity and linearity of the welding seam, avoiding welding defects, enhancing the structural unity and conductivity of the permanent cathode, extending its service life and improving the quality of the product obtained.

The invention consists in automating a welding process between a plate (2), typically of stainless steel 316L, duplex or any type of stainless steel for cathodes, and a conductive bar (3), preferably of copper, of a cathode used in electrolytic processes. The conductive bar comprises a filler portion, which constitutes incorporated welding filler material, used in the welding process to generate the melting, the filler portion being arranged at the lower part of the conductive bar (3), which is in contact with the plate (2) in the cathode assembly. In one embodiment, the filler portion may be a special copper solder alloy.

The conductor bar (3) comprises, in its lower part, a central groove extending longitudinally to receive the plate (2). Typically, the central groove is 3.5 mm wide by 6 mm deep. The filler portion projects from the lower part of the conductive bar (3) extending longitudinally from each side of the central groove, defining a first filler portion and a second filler portion that allows generating the melting for welding on each side of the plate (2). In one embodiment, each filler portion of the conductive bar (3) has a transverse section of 1.6×3 mm.

The process is performed by an automated system (1) comprising a welding table (4), with movable and rotating components, which can hold at least one conductive bar (3) and a plate (2) of a permanent cathode; gripping means, on the welding table (4), to fix and immobilize the conductive bar (3) and plate (2) so that when the welding process is started no deviations occur; at least one welding device (5) that allows to generate a welding bead in a linear, constant and continuous way.

In addition, the welding table (4) includes guides that indicate the position and the place where the conductive bar (3) should be placed and a referential element to place the conductive bar (3) at the same starting point. The rotation of the welding table (4) is performed by rotating means that allow the welding to be generated on both sides of the junction zone of the conductive bar (3) and plate (2) without the need for additional movements of the welding device (5). The welding table (4) comprises drive means or actuators for generating the rotation of the welding table (4), regulating also, its speed, and for activating the movement of the gripping means for fixing and immobilizing the conductive bar (3) and plate (2), defining a clamping pressure. The gripping means comprise hydraulic clamping means for the conductive bar (3) and pneumatic clamping means for the plate (2). The hydraulic clamping means present 3 points of support, promoting the fixation and stability of the bar (3) when it is immobilized. In one embodiment, the hydraulic clamping means correspond to hydraulic pistons with unilateral clamping. In one embodiment, the tightening of the conductive bar (3) is 700 psi.

Additionally and as a result of this automation, the welding table (4) comprises cooling means to maintain a constant temperature while the welding is being carried out. The operation of the cooling means allows to regulate the cooling of the conductive bar (3) to a constant temperature required by the welding process. In one embodiment, the cooling means comprise a tub configured to contain cooling liquid and receive the conductive bar (3); and a cooling system (6) with a pump that supplies the cooling liquid. In one embodiment, the cooling liquid is water and the pump is a 0.5 HP water pump. The tub has a configuration such as to allow the arrangement of hydraulic tightening means for fastening the bar (3).

The welding table (4) further comprises an electrohydraulic power unit (7), for the actuation and control of the gripping means and cooling system (6), in an automated manner without the need for an operator to intervene directly on the welding table (4).

The at least one welding device (5) allows adjusting the speed and amperage at which the welding is performed. The at least one welding device (5) comprises a welding machine (8) connected to a welding robot (9) which controls the movements of the welding machine (8). The welding robot (9) enables the welding machine (8) to weld the conductive bar (3) to the plate (2) from both sides without requiring the welding table (4) to be rotated. The at least one welding device (5) further comprises sensor means for: scanning and detecting the plate (2) and bar (3) to be welded; detecting deviations in the weld due to the difference in the melting points of the materials of the conductive bar (3) and plate (2), to perform an automatic correction in the movement and/or operating parameters of the at least one welding device (5) to ensure the linearity of the weld bead generated. The sensor means are arranged so as to be directed to the lower part of the conductive bar (3), to monitor the filler portion. In one embodiment, the sensor means correspond to laser sensors that track the welding device (5) when the weld is generated. In one embodiment, the welding machine (8) corresponds to a TIG type welding device. In a specific embodiment, the TIG type welding device operates with current parameters of 355 A, speed of 7 mm/second and helium input of 14 LPM, allowing to obtain a welding time of 5 minutes per cathode side. In one embodiment, the welding machine (8) is a 500 AC/DC welding machine.

The operation of the welding machine (8) and the welding robot (9) can be programmed through a robot controller (10) that stores a set of motion sequences defining an operation program for different types of cathodes that can be welded in the automated system (1), where such programs are aimed at minimizing the deformation and overheating of the conductive bar (3).

In one embodiment, the feeding of the conductive bars (3) and plates (2) is carried out by at least one handling device which allows to place said elements on the welding table (4), wherein said at least one handling device can also be used for the removal, from the welding table (4), of the permanent cathode produced. The at least one handling device removes the obtained permanent cathode from the welding table (4) to a required location to then be transported to a final or operating location such as, a final structure, electrolytic cell or storage or distribution areas.

In alternative embodiments, the feeding and positioning of the conductive bar (3) and plate (2) on the welding table (4), and removal of the permanent cathode obtained from the welding table (4) can be performed manually, so that, in case of failure or maintenance of at least one handling device, the process is not stopped.

Both the at least one handling device and the at least one welding device (5) can be programmed to set the number of movements required for the welding process.

The welding table (4) comprises a structural modification that allows the passage and movement of the at least one handling device and the at least one welding device (5) without any risk of collision with the components of the hydraulic table (4).

The automated system (1) is connected to at least one control panel (11) connected to the welding table (4) and to the at least one welding device (5), which contains commands so that an operator can operate the system components without intervening directly on the system. The at least one control panel (11) comprises control means that allow automatic operation of the automated system (1) to perform the welding process. In one embodiment, the control panel (11), is connected to the cooling system (6) and electrohydraulic power unit (7) of the welding table (4) and to the welding robot (9) of the at least one welding device (5). Complementarily, the control panel (11) can operate the automated system (1) in a supervised manner such that an operator must authorize or activate the automated system (1) at each stage of the welding process and/or allows the operator to partially intervene, manually, at some stage of the welding process. The control panel (11) also allows to control and enter relevant parameters of the automated system and process, for example, the speed and amperage of the at least one welding device (5), the pressure for tightening the clamping means of the welding table (4), the speed of rotation of the welding table (4), the operating time of welding cycles, the cooling temperature of the bar (3) by the cooling means and/or to define the amount of movements of the at least one handling device and the at least one welding robot (9).

In one embodiment, the welding process comprises the following steps:
i. Positioning a conductive bar (3) comprising a filler portion, which constitutes incorporated welding filler material, on the welding table (4);
ii. Adjusting the position of the conductive bar (3), fixing it and immobilizing it on the welding table (4);
iii. Positioning a plate (2) on the welding table (4), so that its upper edge that in contact with the lower part of the conductive bar (3), comprising the filler portion, on the welding table (4);
iv. Welding the conductive bar (3) and plate (2) on the first side of the contact zone between the conductive bar (3) and plate (2), generating melting in the filler portion of the conductive bar;
v. Welding the conductive bar (3) and plate (2) on a second side, opposite to said first side, of the contact zone between the conductive bar (3) and plate (2), generating melting in the filler portion of the conductive bar, forming an assembled permanent cathode;
vi. Removing the assembled permanent cathode to a required location.

In one embodiment, for positioning the conductive bar (3) and plate (2) on the welding table (4) the at least one handling device is used, transporting said conductive bar (3) and said plate (2) from a feeding area or location towards the welding table (4). Likewise, the removal of the assembled permanent cathode is performed using the at least one handling device, transporting said assembled permanent cathode from the welding table (4) to a required location, wherein previously, the conductive bar (3) is released from the welding table (4).

The conductive bar (3) is positioned in the tub of the welding table (4), being fixed and immobilized by the gripping means, specifically, through the hydraulic clamping means. In one embodiment, before starting the welding, the level of cooling liquid in the tub of the welding table (4) is checked with respect to the height of the conductive bar (3). In one embodiment, the conductive bar (3) is positioned on the gripping means of the welding table (4), at the starting point indicated by the reference element and guides marking the position and place where the conductive bar (3) should be located.

In one embodiment, the bar (3) conductor, before being positioned on the welding table (4), is mechanized, on its lower part, to include a central groove extending longitudinally to receive the plate (2). Typically, the central groove is 3.5 mm wide by 6 mm deep. The filler portion projects from the bottom of the conductive bar (3) extending longitudinally from each side of the central groove, defining a first filler portion and a second filler portion that allows the melt to be generated for welding on each side of the plate (2). In one embodiment, each filler portion of the conductive bar (3) has a cross section of 1.6×3 mm.

In one embodiment, before positioning the plate (2) on the welding table (4), said plate (2) must be sized or conditioned according to the required permanent cathode format, being necessary, for example, the realization of recesses (windows), lateral perforations, machining a V-cut on the lower edge of the plate (2), among others. The welding process can be applied to new or used plates, being necessary, in the case of used plates (2), depending on their condition, polishing with mechanical systems, smoothing the plate (2) by means of a smoothing system to ensure that the surface is adequate, among other repair actions. The welding process can be applied to new or used conductive bars (3), being necessary in the case of used bars (3), depending on their condition, the straightening, cleaning and/or adjustment of the groove for the accommodation of the plate (2).

To initiate welding, the sensor means of the at least one welding device (5) scans the parts to be welded, to indicate to the welding robot (9) that it may initiate welding. To indicate the start of welding, the sensor means must identify the correct coordinate register of the beginning of the plate (2) in the junction zone with the conductive bar (3), which can correspond to the lateral edge of said plate (2) in the junction zone. In the event that the sensor means do not correctly register the coordinates of the beginning of the plate (2), the sensor means are reset to repeat the reading of the starting point. The welding process must comply with an established sequence, according to a program defined in relation to the type of cathode being welded, in order to minimize deformation and overheating of the conductive bar (3). The sensor means perform a monitoring during the welding to detect deviations in the welding bead, allowing to perform an automatic correction in the movement and/or operating parameters of the at least one welding device (5) to ensure the linearity of the welding bead generated.

In one embodiment, before starting the welding process, the program is selected via the control panel (11).

The steps of welding the conductive bar (3) to the plate (2) from both sides can be performed with or without turning the welding table (4).

After welding on both sides, the welding beads generated at the beginning and end of each section must be sealed.

Once the welding process is completed, the at least one welding device (5) is moved to a neutral position, allowing the entry of the at least one handling device or an operator to perform the removal of the obtained permanent cathode.

The process is repeated for each set of plates (2) and conductive bars (3) to be welded to obtain permanent cathodes.

1. An automated system for welding a permanent cathode plate to a conductive rod to ensure uniformity and linearity of the weld bead, comprising:
a welding table, movable and rotatable, which allows to hold at least one conductive bar and a plate of a permanent cathode, comprising:
cooling means to maintain a constant temperature while the welding is being performed, comprising a tub configured to contain cooling liquid and receive the conductive bar; and a cooling system with a pump that supplies the cooling liquid;
gripping means to fix and immobilize the conductive bar and plate so that when the welding process is started no deviations occur, comprising hydraulic clamping means for the conductive bar and pneumatic clamping means for the plate, wherein the hydraulic clamping means are arranged in the tub of the welding table and have 3 points of support on the conductive bar; and
an electrohydraulic power unit, for the actuation and control of the gripping means and cooling system;
at least one welding device that allows to generate a welding bead in a linear, constant and continuous way, comprising a welding machine connected to a welding robot which controls the movements of the welding machine; sensor means for: scanning and detecting the plate and bar to be welded; detecting deviations in the weld due to the difference in the melting points of the materials of the conductive bar and plate, to perform an automatic correction in the movement and/or operating parameters of the at least one welding device to ensure the linearity of the weld bead generated, wherein the sensor means are arranged so as to be directed to the lower part of the conductive bar; and a robot controller for programming the operation of the welding machine and the welding robot, which stores a set of motion sequences defining a program of operation for different types of cathodes that can be welded in the automated system.

2. The automated system according to claim 1, further comprising at least one handling device for feeding the conductive bar and plate, positioning them on the welding table, and for removing the permanent cathode obtained from the welding table.

3. The automated system according to claim 2, wherein at least one control board or panel connected to the welding table and to the at least one welding device, containing control means that allow the automatic or supervised operation by an operator of the automated system to perform the welding process, being connected to the cooling system and electrohydraulic power unit of the welding table and to the welding robot of the at least one welding device.

4. The automated system according to claim 1, further comprising guides marking the position and place where the conductive bar should be located and a reference element to place the conductive bar at the same starting point.

5. The automated system according to claim 1, comprising rotating means for rotating the position of the welding table.

6. The automated system according to claim 5, comprising drive means or actuators for actuating the rotating means.

7. The automated system according to claim 1, wherein the hydraulic clamping means correspond to hydraulic pistons with unilateral fixing.

8. The automated system according to claim 1, wherein the sensor means correspond to laser sensors.

9. The automated system according to claim 1, wherein the welding machine corresponds to a TIG type welding device.

10. An automated process for weld joining of a cathode plate to a conductive rod ensuring uniformity and linearity of the weld bead, using the automated system of claim 1, comprising the steps of:
i. positioning a conductive bar comprising a filler portion, constituting incorporated welding filler material, on a welding table;
ii. adjusting the position of the conductive bar, fixing and immobilizing it on the welding table, by hydraulic clamping means;
iii. positioning a plate on the welding table, so that its upper edge is in contact with the lower part of the conductive bar, which comprises the filler portion, on the welding table, fixing its position by the pneumatic clamping devices;
iv. welding the conductive bar and plate on a first side of the contact zone between the conductive bar and plate, generating melting in the filler portion of the conductive bar, by means of the at least one welding device;
v. welding the conductive bar and plate on a second side, opposite to said first side, of the contact zone between the conductive bar and plate, generating melting in the filler portion of the conductive bar, forming a permanent armored cathode; and
vi. removing the assembled permanent cathode to a required location.

11. The automated process according to claim 10, wherein for positioning the conductive bar and plate on the welding table at least one handling device is used, transporting said conductive bar and said plate from a feeding area or place towards the welding table.

12. The automated process according to claim 10, wherein for removing the assembled permanent cathode at least one handling device is used transporting said assembled permanent cathode from the welding table to a required location, wherein previously, the conductive bar is released from the welding table.

13. The automated process according to claim 10, wherein before starting the welding process, level of cooling liquid in the tub of the welding table is checked with respect to the height of the conductive bar.

14. The automated process according to claim 13, wherein before being positioned on the welding table, the conductive bar is machined to include a central groove in its lower part which extends longitudinally to receive the plate, so that the filler portion projects from the lower part of the conductive bar extending longitudinally from each side of the central groove, defining a first filler portion and a second filler portion which allows to generate the fusion for welding on each side of the plate.

15. The automated process according to claim 14, wherein before positioning the plate on the welding table, the plate must be sized or conditioned according to the required permanent cathode format.

16. The automated process according to claim 15, wherein to initiate the welding, the sensor means of the at least one welding device scans the parts to be welded, to indicate to the welding robot that it can initiate welding.

17. The automated process according to claim 16, wherein before starting welding, the motion sequence program of the robot controller is selected according to the type of permanent cathode being welded.

18. The automated process according to claim 17, wherein after welding on both sides, the weld beads generated at the beginning and end of each section are sealed.

19. The automated process according to claim 18, wherein once the welding process is completed, the at least one welding device is moved to a neutral position to allow the removal of the permanently assembled cathode.
